(19) United States
(12) Patent Application Publication
(10) Pub. No.: US 2014/0232892 A1
(43) Pub. Date: Aug. 21, 2014

(54) DIGITAL SIGNAL PROCESSOR BUFFER MANAGEMENT

(71) Applicant: WOODMAN LABS, INC., San Mateo, CA (US)

(72) Inventor: Scott Patrick Campbell, Belmont, CA (US)

(73) Assignee: Woodman Labs, Inc., San Mateo, CA (US)

(21) Appl. No.: 13/772,306

(22) Filed: Feb. 20, 2013

(51) Int. Cl. H04N 5/232

(52) U.S. Cl. CPC H04N 5/23245
USPC 348/222.1

(57) ABSTRACT

A camera image sensor captures image data at a first rate, and stores the captured image data at a DSP buffer until it is processed by a DSP image processor. In response to the available capacity at the DSP buffer falling below a first threshold, the DSP buffer notifies the image sensor of the buffer's status, and the image sensor is configured to capture image data at a second rate. The second rate can be associated with a frame rate lower than the frame rate associated with the first rate, and/or can be associated with a resolution less than the resolution associated with the first rate. When the available capacity of the DSP increases, for instance, above a second threshold, the image sensor can be re-configured to capture image data at the first rate, or at a third rate different from the second rate and first rate.

### BACKGROUND

1. Technical Field

This disclosure relates to image capturing, and more specifically, to the use of a digital signal processor (DSP) buffer for storing image data captured at a higher rate than the image processing rate of the DSP.

2. Description of the Related Arts

The advancement of digital video and image encoding has led to increasingly sophisticated image capture techniques at increasingly high resolutions and frame rates. For instance, common media formats, such as Blu-Ray discs, internet video, and cable/satellite television, are able to display content at a 1080P resolution (1920×1080 pixels progressively scanned) at 60 frames per second (“fps”). Certain displays are able to display resolutions of 2560×2048 pixels or 3260×1830 pixels or higher at frame rates of 120 fps or 240 fps or higher. As encoding and display technology advances, frame rates and resolutions will increase accordingly.

The capture of digital images by an image capture device (hereinafter “camera”) is performed by an image sensor. Many types of image sensors are commonly used in cameras and other image-capturing devices, such as charge-coupled devices (CCDs) and complementary metal-oxide-semiconductors (CMOSs). Image sensors convert light, such as light entering the aperture of a camera through a camera lens, into image information. In this way, a camera can “capture” objects before it by converting the light reflected from the objects and passing through the camera lens into an image. Similarly, video can be captured by capturing multiple images successively in time.

Image data captured by an image sensor is captured in a “raw” format—an unprocessed and uncompressed format. Generally, image data is processed and compressed by a DSP prior to the storage of captured image data. The image processing capabilities of a DSP may be limited by the processing speed of the DSP. For instance, a DSP may include an image processor that is able to process image data at a particular processing rate. Unfortunately, the image processing rate of a DSP is often lower than the image capture rate of an image sensor. In such an embodiment, the DSP acts as a bottleneck for the image capture process, and the image sensor is forced to capture images at a lower resolution or at a lower frame rate to compensate. Thus, the image capturing capabilities of an image sensor is often limited by the shortcomings of an associated DSP or image processor.

### BRIEF DESCRIPTIONS OF THE DRAWINGS

The disclosed embodiments have other advantages and features which will be more readily apparent from the following detailed description of the invention and the appended claims, when taken in conjunction with the accompanying drawings, in which:

FIG. 1 is a block diagram illustrating an embodiment of a DSP buffer management system implemented in an image capture system.

FIG. 2 is a block diagram illustrating an embodiment of an image capture and display system environment.

FIG. 3 is a block diagram illustrating an embodiment of an image sensor.

FIG. 4 is a timing diagram illustrating the operation of a DSP buffer management system according to one embodiment.

FIG. 5 illustrates an embodiment of a process for altering the image capture rate of an image sensor based on the status of a DSP buffer, according to one embodiment.

### DETAILED DESCRIPTION

The Figures and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Configuration Overview

An image capture system provides photographers, professional and amateur, a configuration for capturing images and video at resolutions and frame rates that previously required a performance-limiting amount of power for many camera configurations. The cameras described herein may be consumer grade while the configuration of the cameras allows for the capture of images by an image sensor at high resolutions and frame rates, the transfer of image data between the image sensor and a DSP, and the processing of the image data by the DSP without the expense of professional grade equipment.

The image capturing system described herein could be used to allow consumers to capture high-resolution and high-frame rate images and video of local events or activities, including sporting events, theater performances, concerts, weddings, or other events without requiring a professional photographer and advanced camera equipment. It should be noted that for the purposes described herein, video capture is performed by the capture of successive images (“frames”), and thus functionality described herein making reference to one of either video capture or image capture is applicable to both.

The system and method of buffer management described herein allows for the use of a camera to capture very high definition video at frame rates faster than the camera's image processor can normally process by storing the captured video in a buffer. The camera can capture video at higher frame rates until the buffer is filled, beneficially providing the user with the ability to capture video at higher frame rates than otherwise would be possible. For example, a user may be able to capture video at very high frame rates for 10-second bursts. The image processor can then process the captured video stored in the buffer at its normal processing rate.

### Image Capture System Overview

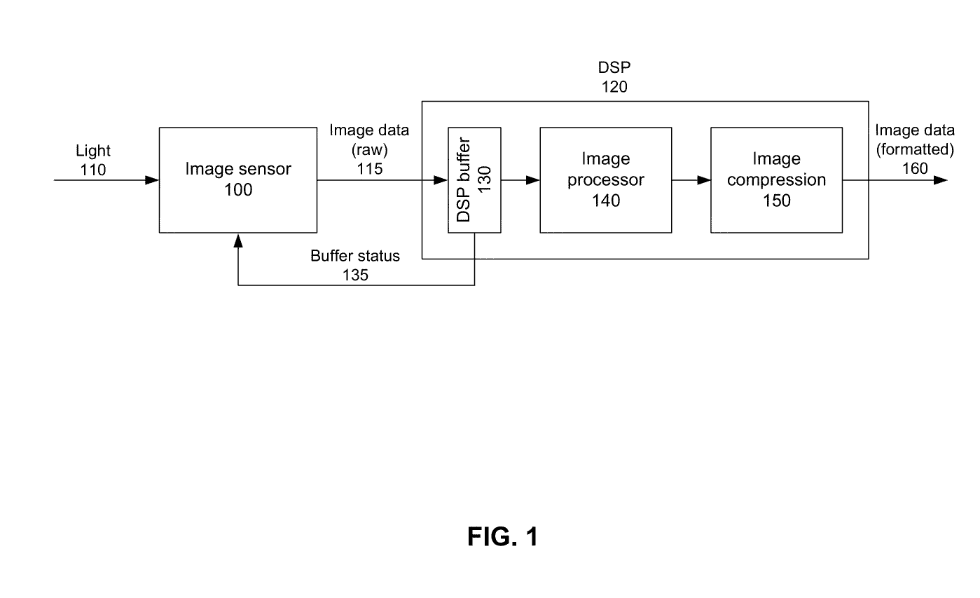

FIG. 1 is a block diagram illustrating an embodiment of a DSP buffer management system implemented in an image capture system. The image capture system includes an image sensor 100 and a DSP 120, each of which may be contained within a camera. Other image capture systems may include additional components or components other than those illustrated herein. Light 110 is captured by the image capture system of FIG. 1, and is converted into formatted image data 160 for storage or viewing by a user of the image capture system.

Light 110 enters the image sensor 100 through, for example, a camera lens and aperture, and is converted into raw image data 115. The raw image data can include a set of electrical signals representative of the photons captured by the image sensor, for instance representations of segments of a captured image referred to herein as pixels. As discussed above, the image sensor can include a CCD or CMOS device. The image sensor can include a focal plane array (FPA) that converts the captured light into pixel data. The image sensor can include a Bayer filter configured to convert captured light into a pixel grid including an array of green pixels, red pixels, and blue pixels. The captured image data is outputted to the DSP 120 as raw image data. In one embodiment, the image sensor outputs raw image data sequentially for each frame of video captured by the image sensor.

As discussed above, the image sensor 100 can capture images at a variety of frame rates or resolutions. The image sensor can also capture images sequentially in video form for either user-determined or pre-determined intervals of time. For example, the image sensor may capture images for a pre-determined interval of 10 seconds, for a user-defined interval of 60 seconds, or from the period of time from when a user configures the image sensor to begin capturing images until the user configures the image sensor to stop capturing images.

The image sensor 100 can include any number of capture modes. Each capture mode is associated with a particular resolution and frame rate, and may be associated with a period of time. When the image sensor is configured to operate in a capture mode, the image sensor captures images at the resolution and frame rate associate with the capture mode, either until the image sensor is configured to stop capturing images or, if the capture mode is associated with a period of time, until the passage of the period of time. The image sensor can automatically be configured to operate in an available capture mode (a capture mode that can be accommodated by the DSP), or can be manually configured by a user of the image capture system to operate in a capture mode selected by the user. The constraints of the DSP 120 can prevent the image sensor from being configured to operate in certain capture modes at certain times, as will be discussed below in greater detail. In one embodiment, the image sensor includes pre-defined captured modes, for instance one capture mode for each combination of resolution and frame rate at which the image sensor can capture images. Similarly, the image sensor can include user-defined capture modes, such that a user of the image capture system can create a user-defined capture mode by selecting a resolution, a frame rate, and a period of time (if desired).

The DSP 120 includes a DSP buffer 130, an image processor 140, and an image compression engine 150. Raw image data 115 is received and stored at the DSP buffer. The DSP buffer can be any non-transitory computer-readable storage, such as flash memory, RAM, or the like. The raw image data is stored at the DSP buffer until it is sent to the image processor for processing. Raw image data can be stored at the DSP buffer in any method suitable to temporarily store the raw image data until it can be processed by the image processor, for instance using a first-in first-out storage scheme. In one embodiment, the image processor notifies the DSP buffer of when the image processor has available image processing capacity, and the DSP buffer, in response to receiving such a notification, sends stored raw image data to the image processor. Alternatively, the image processor can be configured such that the image processor notifies the DSP buffer of when the image processor does not have processing capacity, and the DSP buffer can be configured to only send raw image data to the image processor when the DSP buffer is not receiving such a notification from the image processor. The image processor may be configured to communicate the amount of capacity available for processing image data, for instance by requesting a particular amount of raw image data from the DSP buffer, by requesting a particular number of frames of raw image data from the DSP buffer, or by notifying the DSP buffer of the amount of image processing capacity available at the image processor.

The DSP buffer 130 notifies the image sensor 100 of the DSP buffer status 135. The buffer status can include the available capacity of the DSP buffer for additional raw image data 115 from the image sensor, for instance indicating the amount of memory space available at the DSP buffer, the percentage of capacity available at the DSP buffer, or the amount of time that the DSP buffer can receive and store the raw image data at the data capture rate of the image sensor until the DSP buffer is full. The image sensor, in response to receiving a notification of available capacity at the DSP buffer, can limit subsequently captured additional images such that the raw image data associated with the captured images does not exceed the available capacity at the DSP buffer. Alternatively, the buffer status can merely indicate that the DSP buffer can or cannot store any additional raw image data. In such an embodiment, the image sensor can be configured to capture images only in response to a buffer status that indicates that the DSP buffer can store additional raw image data, and can be configured such that the image sensor does not capture images in response to a buffer status indicating that the DSP buffer cannot store additional raw image data.

The buffer status 135 can also indicate to the image sensor 100 a rate at which the image processor 140 is processing raw image data stored at the DSP buffer 130, the rate at which the DSP buffer is receiving raw image data from the image sensor, and/or accordingly, the rate at which the DSP buffer is being emptied or filled (the difference between the read rate of the image processor and the output rate of the image sensor, hereinafter the “fill rate”). In response to a received buffer status indicating the fill rate and/or the capacity of the DSP buffer 130, the capture rate of the image sensor 100 can be adjusted.

Adjusting the capture rate of the image sensor 100 can include increasing the capture rate of the image sensor. For example, if the buffer status 135 indicates that the fill rate of the DSP buffer 130 is below a particular threshold, and/or that the available capacity of the DSP buffer exceeds a particular threshold, the capture rate of the image sensor can be increased. Increasing the capture rate of the image sensor can include increasing the resolution of captured images, increasing the frame rate of the captured images, or a combination of the two. Adjusting the capture rate of the image sensor can also include decreasing the capture rate of the image sensor. For example, if the buffer status indicates that the fill rate of the DSP buffer is greater than a particular threshold, and/or that the available capacity of the DSP buffer falls below a particular threshold, the capture rate of the image sensor can be decreased. Decreasing the capture rate of the image sensor can include decreasing the resolution of captured images, decreasing the frame rate of the captured images, or a combination of the two. In these embodiments, the selection of a capture rate to which the image sensor increases or decreases can be based on the buffer status. For example, a capture rate can be selected such that when the image sensor increases to the selected capture rate, the DSP buffer can accommodate storing image data captured by the image sensor for a pre-determined period of time, for a pre-determined number of captured frames, and the like. Further, a capture rate can be selected such that when the image sensor decreases to the selected capture rate, the capacity of the DSP buffer decreases to below a particular threshold in a particular amount of time.

The capture rate of the image sensor 100 can be adjusted by configuring the image sensor to operate in a capture mode selected based on a received buffer status 135. If the buffer status 135 indicates that the DSP buffer 130 has an available capacity and/or a fill rate to accommodate a first capture mode associated with an image capture rate higher than the current capture rate of the image sensor, the image sensor can be configured to operate in the first capture mode (for example, either automatically or manually by a user). In this embodiment, operating in the first capture mode can cause the available capacity at the DSP buffer to decrease and/or can cause the fill rate of the DSP buffer to increase. As a result, the buffer status can subsequently indicate to the image sensor that the DSP buffer can no longer accommodate buffering raw image data captured at the resolution and frame rate associated with the first capture mode, or can only accommodate raw image data 115 captured using the first capture mode for a limited amount of time.

Continuing with this embodiment, when the image sensor 100 receives a buffer status 135 indicating that the DSP buffer can no longer accommodate buffering raw image data 115 captured by the image sensor in the first capture mode, the image sensor can be configured to operate in a second capture mode (for example, automatically or manually) associated with a lower frame rate and/or resolution than the first capture mode. It should be noted that buffering raw image data captured by the image sensor while operating in the second capture mode may not necessarily increase the available capacity of the DSP buffer 130 or decrease the fill rate of the DSP buffer, though in such cases, the image sensor may need to be configured to operate in a third capture mode if the available capacity of the DSP buffer decreases below an additional threshold, or if the fill rate of the DSP buffer increases above an additional threshold. In the event that capturing data while the image sensor is configured to operate in the second capture mode decreases the fill rate of the DSP buffer or increases the available capacity of the DSP buffer, the image sensor can be configured to again operate in the first capture mode once the fill rate or available capacity of the DSP buffer can accommodate raw image data captured at the frame rate, resolution, or time interval associated with the first capture mode.

A capture mode for the image sensor 100 can be selected based on the fill rate and/or available capacity of the DSP buffer 130 in a number of ways. In one embodiment, the capture mode associated with the highest resolution, frame rate, time interval, or any combination of the three can be selected such that the DSP buffer has an available capacity and/or fill rate that can accommodate the raw image data 115 captured at the selected capture mode. For example, if the image sensor has a first capture mode associated with 240 fps and a 1080p resolution, and has a second capture mode associated with 120 fps and a 1080p resolution, then if it is determined that the DSP buffer can accommodate (at least, for a period of time) both capture modes, the image sensor can be configured to operate in the first capture mode, since it is associated with the highest frame capture rate. Alternatively, a capture mode can be selected to maximize the amount of time in which the DSP buffer can accommodate raw image data from the image sensor configured to operate in the capture mode. In such an embodiment, the second capture mode from the previous example can be selected over the first capture mode, since the DSP buffer is better able to accommodate image data captured at a lower frame rate. In one embodiment, all available capture modes that can be accommodated by the DSP buffer are identified and are presented to a user of the image capture system for selection.

In one embodiment, while the image sensor 100 is operating in a first capture mode, if the buffer status 135 indicates that the DSP buffer 130 can no longer buffer raw image data 115 captured by the image sensor in the first capture mode, the image sensor can automatically switch to a second capture mode, can prompt a user of the image capture system to select a second capture mode, or can stop capturing images altogether, for instance until the buffer status indicates that the DSP buffer can again accommodate the buffering of raw image data captured by the image sensor at the first capture mode. The image sensor can determine a time period for which the image sensor can capture images at a particular capture mode based on the buffer status, and can indicate the determined time period to a user of the image capture system in association with the particular capture mode such that the user is aware of the time period in which the image sensor can operate in each capture mode. It should be noted that for particular capture modes, the image sensor can capture images indefinitely without causing the available capacity of the DSP buffer to fall below an unacceptable threshold, or without causing the fill rate of the DSP buffer to exceed an unacceptable threshold.

The image processor 140 may be a standalone image processing chip, or may be implemented in a general-purpose processor, such as a microprocessor or an FGPA. Upon receiving buffered raw image data from the DSP buffer 130, the image processor performs a variety of image processing operations on the raw image data. For example, the image processor may perform demosaicing operations, noise reduction operations, image sharpening operations, resolution adjustment, color conversion, brightness adjustment, pixel formatting operations, and the like. After the raw image data is processed, the image processor sends the processed image data to the image compression engine 150. In one embodiment, the image processor does not perform any image processing operations, and instead forwards the raw image data to the image compression engine as processed image data. Alternatively, the image processor may perform operations on the raw image data as required by the image compression engine for subsequent compression.

The image compression engine 150 receives the processed image data and compresses the image data into formatted image data 160. The image compression engine performs one or more compression operations to produce the formatted image data. For example, the image compression engine may compress the processed image data using a wavelet transform or a discrete cosine transform, quantization, entropy encoding, run-length encoding, predictive encoding, deflation, adaptive dictionary algorithms, or any other form of lossless image compression. The image compression engine may compress the processed image data using color space reduction, chroma subsampling, transform codings other than wavelet transforms and DCTs, fractal compression, or other methods of lossy image compression. The image compression engine may compress the processed image data using motion compensation, such as global motion compensation, block motion compensation, variable block-size motion compensation, overlapping block motion compensation, or other methods of motion compensation. The image compression engine may compress the processed image data using 3D coding, for instance using color shifting, pixel subsampling, and enhanced video stream coding.

The formatted image data 160 can be any suitable format for displaying, transmitting, or storing images or video. In one embodiment, the image compression engine 150 compresses the processed image data into image or video formats such as the JPG format, PNG format, Bitmap format, GIF format, MOV format, AVI format, WMV format, H.264, MPEG format, raw image or movie data formats, and the like. Alternatively, the compression engine 150 can compress the processed image data into a non-image/video format, such as the .ZIP format, the .RAR format, and the like. The compression performed by the image compression engine may compress data up to 3 or 4 times or more. The formatted image data is subsequently transmitted to a display for viewing, to a storage module for storage, or to any other suitable component.

### System Architecture

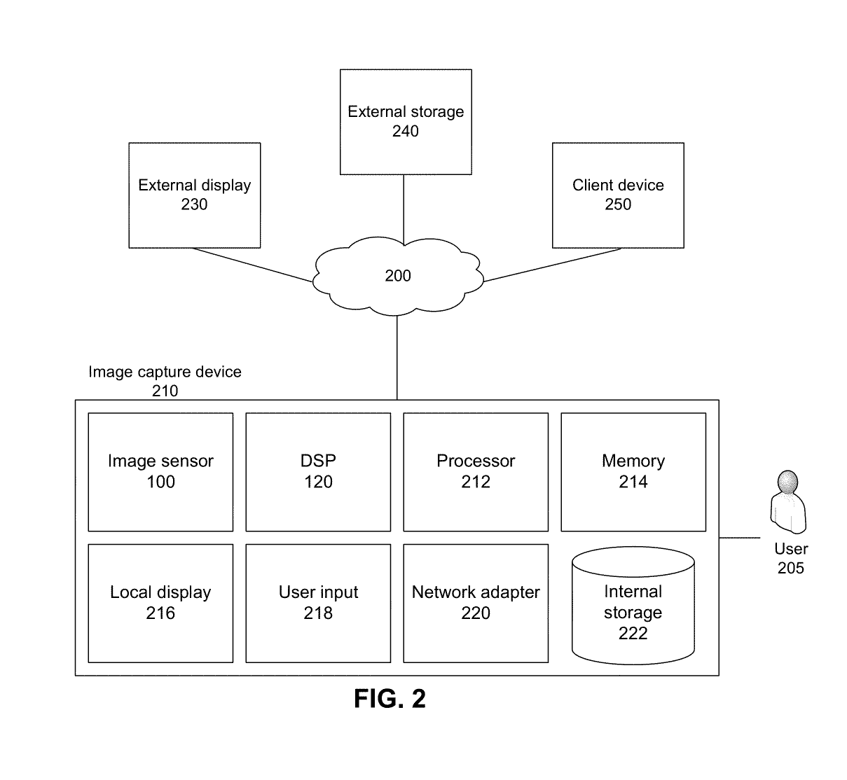

FIG. 2 is a block diagram illustrating an embodiment of an image capture and display system environment. In the environment of FIG. 2, an image capture device 210, an external display 230, an external storage module 240, and a client device 250 all communicate through a connecting network 200. Other embodiments of such an environment may contain fewer or additional modules, which may perform different functionalities than described herein. Although only one of each component is illustrated in the environment of FIG. 2, other embodiments can have any number of each type of component, such as thousands or millions. A user 205 can operate the image capture device and/or the other components of FIG. 2 as described herein.

The image capture device 210 and other components of FIG. 2 may be implemented in computers adapted to execute computer program modules. For example, the image capture device 210 may be a standalone camera, a mobile phone, a tablet computer, a camera communicatively coupled to a computer, and the like. As used herein, the term “module” refers to computer-readable program instructions and/or data for providing the specified functionality. A module can be implemented in hardware, firmware, and/or software. In one embodiment, the modules are stored on one or more storage devices, loaded into memory, and executed by the processors. Storage devices, memory, and processors are described in greater detail in the description of the image capture device below; this description applies equally to any of the components of FIG. 2.

The image capture device 210 of the embodiment of FIG. 2 includes the image sensor 100, the DSP 120, a processor 212, memory 214, a local display 216, a user input 218, a network adapter 220, and an internal storage module 222. In other embodiments, the image capture device may include fewer or additional components not shown for the purposes of simplicity. For instance, the image capture device may include an internal bus, allowing the components of the image capture device to communicate. In addition, not shown are common components of an image capture device, such as a lens, an aperture, a battery or other power supply, communication ports, speakers, a microphone, and the like. The image sensor is configured to capture images, which are then processed and/or formatted by the DSP and stored in a storage module, such as the internal storage module or the external storage module 240. In one embodiment, the image sensor and the DSP are the image sensor and the DSP of the embodiment of FIG. 1.

The processor 212 may be any general-purpose processor. The processor is configured to execute instructions, for example, instructions corresponding to the processes described herein. The memory 214 may be, for example, firmware, read-only memory (ROM), non-volatile random access memory (NVRAM), and/or RAM. The internal storage module 222 is, in one embodiment, an integrated hard disk drive or solid state memory device, though in other embodiments may be a removable memory device, such as a writeable compact disk or DVD, a removable hard disk drive, or a removable solid state memory device. The memory and/or the internal storage module are configured to store instructions and data that can be executed by the processor to perform the functions related to the processes described herein. In one embodiment, the functionalities performed by the image sensor 100 or its components or the DSP 120 or its components are performed by the processor and instructions stored in the memory and/or the internal storage module.

The local display 216 may be implemented with an integrated LCD screen or other similar screen, such as a monochromatic display or other display. Alternatively, the local display may be implemented with a removable display module, such as a LCD pack configured to couple to the image capture device 210 and communicate with the components of the image capture device through an internal bus.

The local display 216 may be configured to operate as a user interface for the user 205. In one embodiment, the local display displays menus, HUDs, UIs, and the like to allow the user to utilize the functionalities of the image capture device or to inform the user of information related to the image capture device, such as the amount of available storage remaining, the amount of power remaining, the current resolution and/or frame rate of the image capture device, the available capacity of the DSP buffer 130, the fill rate of the DSP buffer, and any other settings or information related to the image capture device. In one embodiment, the image capture device is configured to perform the functions of an electronic view finder, allowing the user to view the images and/or video that the image capture device will capture or is capturing responsive to a capturing action performed by the user on the image capture device. In one embodiment, the local display is configured to display previously captured images and videos. A local display interface can be configured to display available capture modes for the image sensor 100 for selection by the user.

The user input 218 comprises a solid state and/or mechanical interface. For example, the user input may include one or more buttons on the exterior of the image capture device 210. The user input is configured to receive a selection action from the user 205 of the image capture device and allows the user to interact with the image capture device. Alternatively, the user input may include a touch-screen component of the local display 216, an external input device, such as a keyboard, mouse or other controller configured to communicate with the image capture device via an input port or the network adapter 220, or any other means of interacting with the image capture device. The user may use the user input to interact with the image capture device and perform functions of the image capture device, such as navigating through previously captured images or video, editing or deleting previously captured images or video, altering the image capture device's settings (such as the resolution or frame rate of future captured images or video, adjusting a power-save mode, or adjusting other camera parameters or settings, such as a night/day mode, a self-timer, an exposure length, and the like), turning the image capture device on and off, communicating with external modules via the network adapter, and so forth. In one embodiment, the user input is configured to allow the user to select an available capture mode in order to configure the image sensor 100 to capture images at a frame rate and resolution associated with the selected capture mode.

The network adapter 220 communicatively couples the image capture device 210 to external modules via the connecting network 200. The network adapter may include a network card, a modem, or any device configured to allow the image capture device to communicate with the other components of FIG. 2 via the connecting network and vice versa.

The connecting network 200 enables communications among the entities connected to it. In one embodiment, the connecting network is the internet and uses standard communications technologies and/or protocols. Thus, the connecting network can include links using technologies such as Ethernet, 802.11, worldwide interoperability for microwave access (WiMAX), long term evolution (LTE), 3G, and the like. Similarly, the networking protocols used on the connecting network can include multiprotocol label switching (MPLS), the transmission control protocol/Internet protocol (TCP/IP), the User Datagram Protocol (UDP), the hypertext transport protocol (HTTP), the simple mail transfer protocol (SMTP), the file transfer protocol (FTP), and the like. The data exchanged over the connecting network can be represented using technologies and/or formats including the hypertext markup language (HTML), the extensible markup language (XML), and the like. At least a portion of the connecting network can comprise a mobile (e.g., cellular or wireless) data network such as those provided by wireless carriers. In some embodiments, the connecting network comprises a combination of communication technologies.

The external display 230 may include any type of display configured to display images or videos captured by the image capture device 210, menus or other interfaces of the image capture device, or any other content from the image capture device. For example, the external display may be a television, a monitor, a mobile phone, and the like. The external display may receive content from the image capture device from the image capture device via the connecting network 200, or from the external storage module 240, the client device 250, and the like.

The external storage module 240 is configured to receive and store content from the image capture device 210. In one embodiment, the external storage module includes a database, a datacenter, an external hard disk drive, an external computer, and the like. The external storage module may further be configured to provide stored content to the components of the embodiment of FIG. 2. For instance, the user 205 may retrieve previously stored images or video from the external storage module for display on the image capture device or the external display 230, or for interaction with by the client device 250.

The client device 250 comprises a computer, tablet computer, mobile phone or other mobile device, remote control, or any other electronic device operated by the user 205 to interact with the image capture device 210. The client device can be used to start and stop image capture at the image capture device, to select a capture mode with which to configure the image capture device, to view image and video previously captured by the image capture device, as an electronic viewfinder for the image capture device, and the like. For example, in one embodiment, the client device includes a mobile device executing a web browser or native application that can configure the image capture device.

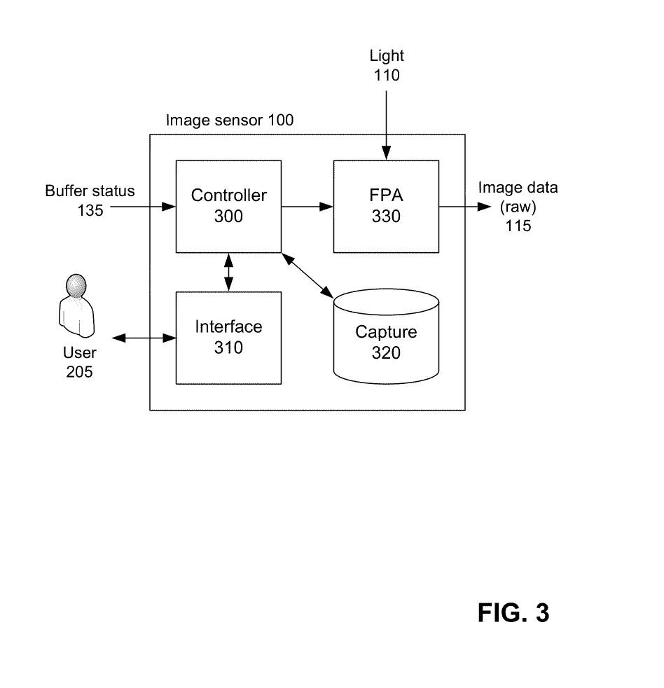

FIG. 3 is a block diagram illustrating an embodiment of an image sensor 100. The image sensor of FIG. 3 includes a controller 300, an interface 310, a capture storage module 320, and an FPA 330. In other embodiments, the image sensor includes different components than those illustrated in FIG. 3. In one embodiment, the image sensor is the image sensor of FIG. 1. The controller instructs the FPA to begin capturing light 110 at a first resolution and frame rate, and in response, the FPA outputs the captured light as the raw image data 115. The first resolution and frame rate can be a default resolution and frame rate or a resolution and frame rate selected by a user 205.

The controller 300 receives a buffer status 135 from a DSP buffer, such as the DSP buffer 130 of FIG. 1. In response to receiving the buffer status, the controller can instruct the FPA 330 to begin capturing light 110 at a second resolution and frame rate. The buffer status can indicate that the DSP buffer associated with the buffer status has below a threshold level of available capacity. In response, the controller can identify a second, lower frame rate and/or resolution than the first frame rate and resolution based on the received buffer status. Selecting a second, lower resolution and frame rate based on the buffer status can include identifying a maximum resolution and frame rate that the DSP buffer associated with the buffer status can accommodate (either permanently or for a period of time), a default resolution and frame rate associated with the received buffer status, a resolution and frame rate that can maximize the amount of time the DSP buffer can accommodate, and the like. The buffer status can indicate that the DSP buffer associated with the buffer status has above a threshold level of available capacity, and in response, the controller can identify a second, higher frame rate and/or resolution than the first frame rate and resolution based on the received buffer status. Selecting a second, higher resolution and frame rate based on the buffer status can include identifying a maximum resolution and frame rate that the DSP buffer associated with the buffer status can accommodate (either permanently or for a period of time), a default resolution and frame rate associated with the received buffer status, and the like. It should be noted that in one embodiment, selecting a second frame rate and resolution can involve selecting a different frame rate and keeping the first resolution, and vice versa. Further, selecting a second frame rate and resolution can include selecting one pre-determined level of frame rate and/or resolution higher or lower than the first frame rate and resolution.

The controller 300 can instruct the FPA 330 to begin capturing light 110 according to a first capture mode stored in the capture storage module 320. The capture storage module can store any number of pre-defined or user-defined captured modes. In one embodiment, each capture mode stored at the capture storage module includes a resolution and frame rate. In response to receiving a buffer status 135, the controller can instruct the FPA to begin capturing light according to a second capture mode stored in the capture storage module. If the buffer status indicates that the DSP buffer associated with the buffer status has below a threshold level of available capacity, the controller can select a second capture mode associated with a frame rate and/or resolution lower than the frame rate and/or resolution of the first capture mode. Similarly, if the buffer status indicates that the DSP buffer associated with the buffer status has above a threshold level of available capacity, the controller can select a second capture mode associated with a frame rate and/or resolution higher than the frame rate and/or resolution of the first capture mode.

The controller 300 can use the interface 310 to display one or more configuration options to the user 205. In one embodiment, the controller displays various resolutions and frame rates to the user, and in response to receiving a selection of a resolution and frame rate from the user, configures the FPA to capture light 110 according to the selected frame rate and resolution. The controller can also display one or more capture modes to the user via the interface, and can configure the FPA to capture light according to a select capture mode. In one embodiment, the controller allows the user to define a capture mode using the interface, and can store a defined capture mode in the capture storage module 320.

The controller 300 can display various configuration options to the user 205 based on the received buffer status 135. If the buffer status indicates that the available capacity of a DSP buffer associated with the buffer status falls below a particular threshold, the controller can prompt the user via the interface to select a lower frame rate and/or resolution than the current frame rate and resolution of capture by the FPA 330, or to select a capture mode associated with a lower frame rate and/or resolution. In such an embodiment, the controller can display via the interface all frame rates, resolutions, and/or capture modes associated with a lower frame rate and/or resolution than the current frame rate and resolution, the user can select a displayed frame rate, resolution, or capture mode, and the controller can instruct the FPA to begin capturing light at the selected frame rate and/or resolution or according to the selected capture mode. Similarly, if the buffer status 135 indicates that the available capacity of a DSP buffer associated with the buffer status exceeds a particular threshold, the controller can display via the interface frame rates, resolutions, and/or capture modes associated with a higher frame rate and/or resolution than the current frame rate and resolution for the user to select.

### Operational Configurations

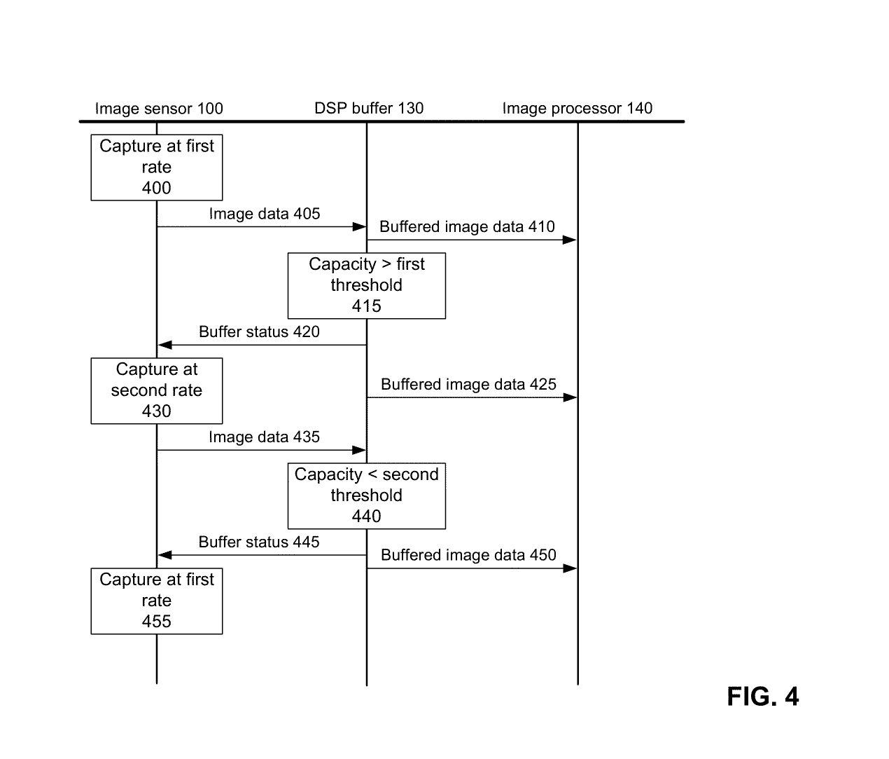

FIG. 4 is a timing diagram illustrating the operation of a DSP buffer management system according to one embodiment. An image sensor 100 is configured 400 to capture images at a first rate. For example, the image sensor can be configured to capture images at a resolution of 1080p and at 240 fps. Image data captured at this first rate is sent 405 to a DSP buffer 130 and is buffered until an associated image processor 140 has capacity to process the buffered image data, at which point the buffered image data is sent 410 to the image processor for image processing. In one embodiment, the image processor requests the buffered image data from the DSP buffer any time the image process has capacity to process image data and the DSP buffer is storing buffered image data. In such an embodiment, the image processor continually requests, receives, and processes buffered image data until the DSP buffer no longer stores any image data. While the image sensor is capturing data at the first rate, the rate of the image data being sent to the DSP buffer exceeds the rate of buffered image data being sent to the image processor, resulting in a positive fill rate, the filling of the DSP buffer, and the decreasing in available capacity within the DSP buffer.

When the capacity of the DSP buffer 130 exceeds 415 a first threshold (for instance, 80% capacity), the DSP buffer sends 420 a buffer status indicating that the capacity of the DSP buffer exceeds the first threshold. In response, the image sensor 100 is configured 430 to capture images at a second rate. The second rate includes either a lower resolution or a lower frame rate, or both, than the first rate. For example, the image sensor can be configured to capture images at a resolution of 1080p and 120 fps, or at a resolution of 720p and 240 fps. Meanwhile, buffered image data is sent 425 to the image processor 140 for processing.

The image data captured 430 by the image sensor 100 at the second rate is sent 435 to the DSP buffer 130. In one embodiment, the second rate at which the image sensor captures image data is selected such that the rate at which the image data is sent from the image sensor to the DSP buffer is less than the rate at which buffered image data is sent 425 from the DSP buffer to the image processor 140. In this embodiment, the fill rate of the DSP buffer is negative, and the available capacity within the DSP buffer is increased.

When the capacity of the DSP buffer 130 falls below 440 a second threshold (for instance, the same 80% capacity of the first threshold, or a lower capacity, such as a 20% capacity), a buffer status is sent 445 to the image sensor 100 indicating that the capacity of the DSP buffer has fallen below the second threshold. In response, the image sensor can optionally be configured 455 to capture images at the first rate. Alternatively, the image sensor can be configured to capture images at a third rate, different from the first rate and the second rate, can be configured to continue to capture images at the second rate, or can be configured to stop capturing images. Meanwhile, buffered image data is sent 450 from the DSP buffer to the image processor 140 until the DSP buffer is emptied of buffered data.

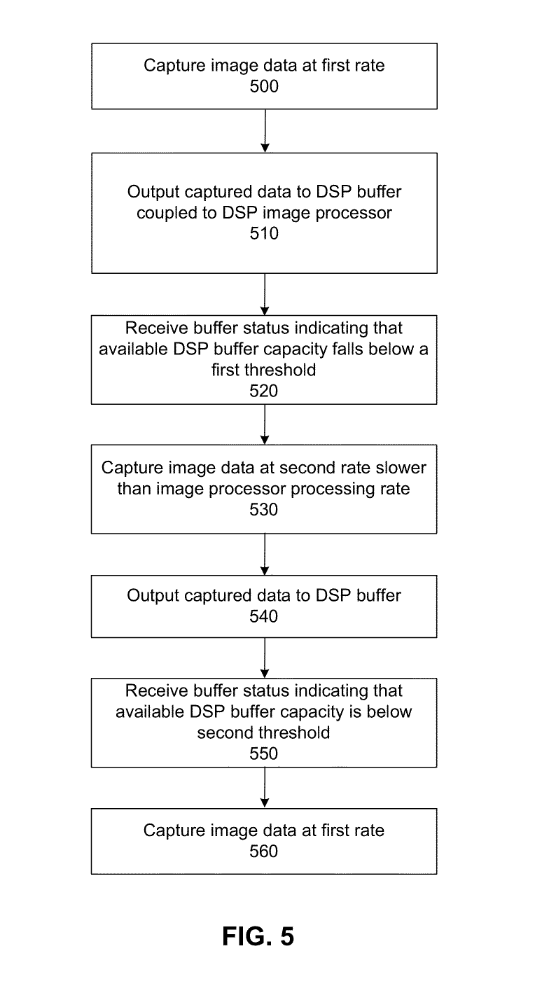

FIG. 5 illustrates an embodiment of a process for altering the image capture rate of an image sensor based on the status of a DSP buffer, according to one embodiment. Image data is captured 500 at a first rate. Capturing image data at a first rate can include configuring an image sensor to capture images at a first resolution and first frame rate. In one embodiment, image data is captured at a first rate in response to the configuration of a camera to capture images at the first rate by a user. The captured image data is outputted 510 to a DSP buffer coupled to a DSP image processor configured to process image data buffered at the DSP buffer.

A buffer status is received 520 from the DSP buffer indicating that the available DSP buffer capacity falls below a first threshold. The available DSP buffer capacity can decrease over time in response to the image processing rate of the DSP image processing being lower than the rate at which captured image data is received at the DSP buffer. In response to receiving the buffer status indicating that the available DSP buffer capacity falls below the first threshold, image data is captured 530 at a second rate. Capturing image data at the second rate can include configuring an image sensor to capture images at a second resolution and a second frame rate. The second rate can be lower than the DSP image processor processing rate, or can be lower than the first rate. In one embodiment, the second rate is selected automatically, for instance, by an image sensor or a camera, or manually, for instance, by a user of a camera. The second can be selected as the fastest rate at which image data is captured such that the available capacity of the DSP buffer does not decrease.

Image data captured at the second rate is outputted 540 to the DSP buffer. In the event that a buffer status is received 550 indicating that the available DSP buffer capacity is below a second threshold, image data can again be captured 560 at a first rate. It should be noted that capturing image data at the second rate does not guarantee that the available DSP buffer capacity will eventually fall below a second threshold (for instance, in embodiments where the rate at which the image data is sent to the DSP buffer is substantially equal to the rate at which the DSP image processor is processing image data. In such embodiments, image data may continue to be captured at the second rate, or may instead be captured at a third rate, different from the first rate and the second rate.

It is noted that terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Finally, as used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Upon reading this disclosure, those of skill in the art will appreciate still additional alternative structural and functional designs for a broadcast management system as disclosed from the principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A camera system for capturing images, the camera system including an image sensor, a digital signal processor (DSP) buffer, and a DSP image processor, the camera system configured to perform camera operations comprising:
capturing, by the image sensor, frames of video according to a first capture mode, the first capture mode comprising a first resolution and a first frame rate;
outputting the frames of video captured according to the first capture mode from the image sensor to the DSP buffer;
in response to an available DSP buffer capacity falling below a first threshold, prompting a user of the camera system via a camera system interface to select a second capture mode; and
capturing, by the image sensor, frames of video according to the selected second capture mode.

2. The camera system of claim 1, wherein the second capture mode comprises a second resolution and a second frame rate, and wherein the second resolution is less than the first resolution and/or the second frame rate is lower than the second frame rate

3. The camera system of claim 1, wherein the camera system is further configured to perform camera operations comprising:
in response to an available DSP buffer capacity exceeding a second threshold, prompting the user of the camera system via the camera system interface to select a third capture mode; and
capturing, by the image sensor, frames of video according to the selected third capture mode.

4. The camera system of claim 3, wherein the third capture mode comprises a third resolution and a third frame rate, and wherein the third resolution is greater than one or more of the first resolution and the second resolution, and/or wherein the third frame rate is greater than one or more of the first frame rate and the second frame rate.

5. The camera system of claim 1, wherein the first capture mode comprises a resolution of 1080P and a frame rate of 240 fps, and wherein the second capture mode comprises a resolution of 1080P and a frame rate of 120 fps.

6. The camera system of claim 1, wherein at least one of the first capture mode and the second capture mode are user-defined.

7. A method for capturing images with a camera, the method comprising:
capturing, by an image sensor, image data at a first rate;
outputting the image data captured at the first rate to a DSP buffer, the DSP buffer configured to buffer received image data for processing by a DSP image processor;
receiving a buffer status from the DSP buffer indicating that the available storage capacity at the DSP buffer falls below a first threshold;
in response to the received buffer status, capturing, by the image sensor, image data at a second rate, the second rate lower than the first rate; and
outputting the image data captured at the second rate to the DSP buffer.

8. The method of claim 7, further comprising:
receiving a second buffer status from the DSP buffer indicating that the available storage capacity at the DSP buffer exceeds a second threshold; and
in response to the received buffer status, capturing, by the image sensor, image data at a third rate, the third rate higher than the second rate.

9. The method of claim 8, wherein the third rate is equal to the first rate.

10. The method of claim 7, wherein capturing image data at a first rate comprises capturing images at a first resolution and at a first frame rate, and wherein capturing image data at a second rate comprises capturing images at a second resolution and at a second frame rate.

11. The method of claim 10, wherein the second resolution is less than the first resolution and/or wherein the second frame rate is lower than the first frame rate.

12. The method of claim 7, further comprising:
processing, by the DSP image processor, image data buffered by the DSP buffer;
compressing the processed image data into one or more images; and
storing the one or more images in a non-transitory computer-readable storage medium.

13. The method of claim 7, wherein the captured image data comprises captured frames of video.

14. A system for compressing image data, the system comprising:
a DSP buffer, the DSP buffer comprising a non-transitory computer-readable storage medium and coupled to a DSP image processor, and configured to:
buffer received image data;
output a first buffer status in response to the available capacity of the DSP buffer falling below a first threshold;
output buffered data to the DSP image processor; and
an image sensor configured to:
capture image data at a first rate;
output the image data captured at the first rate to the DSP buffer for buffering;
in response to receiving the first buffer status from the DSP buffer:
capture image data at a second rate lower than the first rate; and
output the image data captured at the second rate to the DSP buffer for buffering.

15. The system of claim 14, wherein the DSP buffer is further configured to output a second buffer status in response to the available capacity of the DSP buffer exceeding a second threshold, and wherein the image sensor is further configured to, in response to receiving the second buffer status from the DSP buffer:
capture image data at a second rate higher than the third rate; and
output the image data captured at the third rate to the DSP buffer for buffering.

16. The system of claim 15, wherein the third rate is equal to the first rate.

17. The system of claim 14, wherein capturing image data at a first rate comprises capturing images at a first resolution and at a first frame rate, and wherein capturing image data at a second rate comprises capturing images at a second resolution and at a second frame rate.

18. The system of claim 17, wherein the second resolution is less than the first resolution and/or wherein the second frame rate is lower than the first frame rate.

19. The system of claim 14, wherein the DSP image processor is configured to:
process image data buffered by the DSP buffer;
compress the processed image data into one or more images; and
store the one or more images in a non-transitory computer-readable storage medium.

20. The system of claim 14, wherein the captured image data comprises captured frames of video.
